(19) United States
(12) Patent Application Publication
(10) Pub. No.: US 2010/0128671 A1
(43) Pub. Date: May 27, 2010

(54) Interference-free antenna module and WiFi network system using the antenna module

(75) Inventors: Michael Chen, Hsin-Chu (TW); Ming-Chen Chou, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: Kuang Sheng Yun Ltd., Hsinchu City (TW)

(21) Appl. No.: 12/458,290

(22) Filed: Jul. 8, 2009

(30) Foreign Application Priority Data
Nov. 27, 2008 (TW) 097145938

(51) Int. Cl. H04W 4/00

(52) U.S. Cl. 370/328

(57) ABSTRACT

An interference-free antenna module includes a WiFi interference-free antenna module having a plurality of high frequency transceivers respectively facing different directions, and an antenna controller electrically coupled to the high frequency transceivers respectively. The antenna controller receives a signal transmitting/receiving request output by a signal processor to accordingly select one of the high frequency transceivers to transmit or receive a circularly polarized high frequency signal. The antenna module also includes a consumer equipment interference-free antenna module having a circular polarization antenna unit. The WiFi network system includes a WiFi base station and a consumer equipment.

### BACKGROUND OF THE INVENTION

1. Field of the Invention

The present invention relates to an interference-free antenna module and a wireless fidelity (WiFi) network system and, more particularly, to an interference-free antenna module capable of improving the efficiency and the signal to noise ratio (SNR) of the transmission of a high frequency signal between a WiFi base station and a consumer equipment, and the system using the interference-free antenna module to effectively expand the coverage of the WiFi base station under the condition of maintaining a desired quality of service (QoS) in addition to improving the efficiency of the transmission of a high frequency signal between a WiFi base station and a consumer equipment.

2. Description of Related Art

In recent years, WiFi technology has been widely implemented in the wireless network systems of metropolitan areas, and people can access internet wherever by using a notebook computer or a personal digital assistant (PDA) with wireless capabilities, thereby gaining the goal of mobile broadband. As shown in FIG. 1, a typical WiFi network system includes a WiFi base station 11 and a consumer equipment 12. The WiFi base station 11 is electrically coupled to a remote server 14 (such as a digital switch) through a physical network line 13. The consumer equipment 12 (such as a cell phone, a notebook computer, a PDA and the like) transmits signals to the WiFi base station 11 via wireless network, and the WiFi base station subsequently forwards the signals to the remote server 14 through the physical network line 13. Similarly, the signals are delivered in reverse direction to the WiFi base station 11 through the physical network line 13 and subsequently transmitted to the consumer equipment 12 covered by the WiFi base station 11 via wireless network.

Therefore, the efficiency of wireless network in transmitting signals between a WiFi base station and a consumer equipment in a typical WiFi network system is quite important. In addition, buildings, moving vehicles and dirty air particles in a metropolitan area can cause poor transmission efficiency of the wireless network. Therefore, it is hard to raise the signal to noise ratio (SNR) on signal transmission, and likely resulting in signal loss. In order to maintain a desired QoS, for the typical WiFi network system, it is necessary to reduce the coverage of the WiFi base station. However, it largely increases the entire deployment cost of the typical WiFi network system, for it requires more WiFi base stations, which may affect on the health of people around the WiFi base stations.

To overcome the aforementioned problems, in the industry, a smart antenna is proposed as a solution to replace the antenna of the WiFi base station. The smart antenna can only receive the high frequency signals which are at a specific frequency, from a specific direction, and within a special time slot. Accordingly, other high frequency signals with different frequencies or from different directions (such as the high frequency signals reflected by the buildings or transmitted to the WiFi base stations by other consumer equipments) are not received by the smart antenna, and the signal transmission efficiency between the WiFi base station and the consumer equipment is improved. However, the smart antenna is very expensive; the cost could be even higher than the entire WiFi base station. Thus, for the industry, WiFi base stations with the smart antenna could not be implemented widely. Namely, the aforementioned solution by using the smart antenna could only solve the aforementioned problem partially. Therefore, it is desirable to provide an improved antenna and WiFi network system to mitigate and/or obviate the aforementioned problems.

Therefore, there is a need for the industry to have an interference-free antenna module, which is capable of improving the transmission efficiency of high frequency signals between a WiFi base station and a consumer equipment, and a WiFi network system, which is capable of improving the transmission efficiency of high frequency signals between a WiFi base station and a consumer equipment, and effectively expanding the coverage area of WiFi base stations under the condition of maintaining a certain level of quality of service (QoS).

### SUMMARY OF THE INVENTION

An object of the present invention is to provide an interference-free antenna module, which can increase the signal transmission efficiency between a WiFi base station and a consumer equipment and also the SNR of high frequency signal transmission.

Another object of the present invention is to provide a WiFi network system, which can increase the signal transmission efficiency between a WiFi base station and a consumer equipment, and effectively expand a coverage of the WiFi base station while maintaining a desired QoS.

To achieve the objects, an interference-free antenna module is provided, which is implemented in a wireless fidelity (WiFi) base station with a signal processor and applied to a high frequency signal transmission between the WiFi base station and a consumer equipment. The antenna module includes a plurality of high frequency transceivers facing different directions respectively, and an antenna controller electrically coupled to the high frequency transceivers. The antenna controller is electrically coupled to the signal processor in order to receive a signal transmitting/receiving request output by the signal processor to accordingly select a high frequency transceiver to transmit or receive a circularly polarized high frequency signal. In addition, the interference-free antenna module is also implemented in a consumer equipment, and it includes a consumer equipment interference-free antenna module and a second signal processor. The consumer equipment interference-free antenna module has a circular polarization antenna unit to transmit or receive a circularly polarized second high frequency signal.

To achieve the objects, a WiFi network system is provided. The system includes: a WiFi base station having an interference-free antenna module and a first signal processor, the interference-free antenna module having a plurality of first high frequency transceivers and a first antenna controller electrically coupled to the first high frequency transceivers respectively, the first antenna controller being electrically coupled to the first signal processor for selecting one of the first high frequency transceivers to transmit or receive a circularly polarized first high frequency signal based on a signal transmitting/receiving request output by the first signal processor; and a consumer equipment having a consumer equipment interference-free antenna module and a second signal processor, the consumer equipment interference-free antenna module having a circular polarization antenna unit to transmit or receive a circularly polarized second high frequency signal. The first high frequency transceivers face different directions respectively, and one of them faces the consumer equipment.

Therefore, the high frequency signals transmitted by the high frequency transceivers of the interference-free antenna module in the invention have a circular polarization characteristic (such as a left-hand circular polarization), and when the circularly polarized high frequency signals are reflected by an obstacle (such as a building or vehicle), the circular polarization characteristic is consequently changed (such as changed from a left-hand circular polarization into a right-hand circular polarization). Therefore, only a high frequency signal with a specific circular polarization (such as a left-hand circular polarization) can be delivered to the signal processor of the consumer equipment. In this case, even if the reflected high frequency signal or signals are delivered to the circular polarization antenna unit of the consumer equipment, they cannot enter the signal processor of the consumer equipment due to the right-hand circular polarization characteristic. Namely, the noises produced by the reflected high frequency signal or signals are effectively suppressed, so the SNR of transmitting the high frequency signals can be raised and the transmission efficiency of the high frequency signal between a WiFi base station and a consumer equipment is raised.

Similarly, since the high frequency transceivers of the respective antenna modules of both the WiFi base station and the consumer equipment in the WiFi network system can transmit or receive a circularly polarized high frequency signal, the corresponding consumer equipment (or the WiFi base station) can easily receive a high frequency signal with a specific circular polarization when the WiFi base station (or the consumer equipment) transmits the high frequency signal with the specific circular polarization, and the SNR and transmission efficiency of transmitting the high frequency signal are accordingly raised. Therefore, the coverage of the WiFi base station in the WiFi network can be expanded while the system maintains the desired QoS.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a typical WiFi network system;

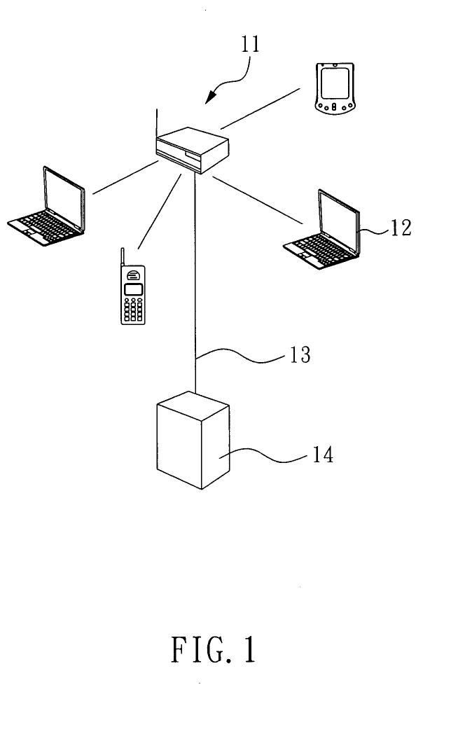

FIG. 2 is a schematic view of an interference-free antenna module according to an embodiment of the invention;

FIG. 3 is a schematic view of a WiFi network system according to an embodiment of the invention;

FIG. 4 is a schematic view of a WiFi base station of a WiFi network system according to an embodiment of the invention;

FIG. 5 is a schematic view of a WiFi base station of a WiFi network system that is installed on the roof of a room according to an embodiment of the invention; and

FIG. 6 is a schematic view of a consumer equipment interference-free antenna module of a WiFi network system according to an embodiment of the invention.

### DETAILED DESCRIPTION OF THE PREFERRED EMBODIMENT

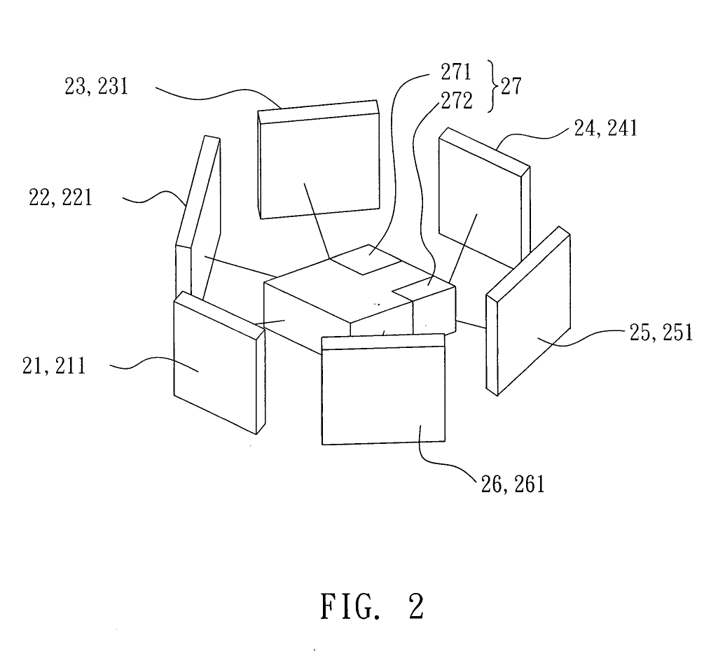

FIG. 2 is a schematic view of an interference-free antenna module according to an embodiment of the invention. As shown in FIG. 2, the module includes a plurality of high frequency transceivers 21 to 26 and an antenna controller 27. The high frequency transceivers 21 to 26 face different directions respectively, and the antenna controller 27 is electrically coupled to the high frequency transceivers 21 to 26 respectively.

In addition, the WiFi base station (shown later) with the interference-free antenna module has a signal processor (shown later), and the antenna controller 27 is electrically coupled to the signal processor. The antenna controller 27 is based on a signal transmitting/receiving request output by the signal processor to select one of the high frequency transceivers 21 to 26 to transmit or receive a circularly polarized high frequency signal.

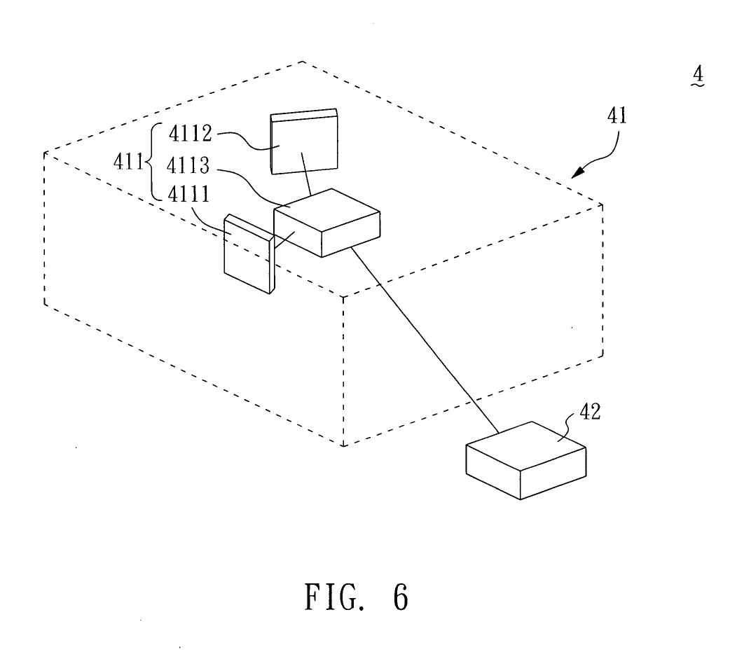

As shown in FIG. 6, the consumer equipment in this embodiment includes a consumer equipment interference-free antenna module 41 and a second signal processor 42. The consumer equipment interference-free antenna module 41 has a circular polarization antenna unit 411. In this embodiment, the circular polarization antenna unit 411 includes a horizontal antenna portion 4111, a vertical antenna portion 4112 and a signal mixing portion 4113, and the signal mixing portion 4113 is electrically coupled to the horizontal antenna portion 4111 and the vertical antenna portion 4112 respectively. In addition, a horizontal high frequency signal transmitted or received by the horizontal antenna portion 4111 and a vertical high frequency signal transmitted or received by the vertical antenna portion 4112 have a 90-degree phase difference.

Besides, the antenna module is implemented in a WiFi base station (shown later) and applied to the transmission of high frequency signals between the WiFi base station (shown later) and the interference-free antenna module of the consumer equipment (shown later).

The interference-free antenna module shown in FIG. 2 has six high frequency transceivers 21 to 26, each of them is a patch array antenna and has a rectangle plate 211, 221, 231, 241, 251, 261 respectively. In this embodiment, the six rectangle plates 211, 221, 231, 241, 251, 261 have a size of 5 cm×5 cm. Besides, the antenna controller 27 includes a circular polarization filter portion 271 to filter the high frequency signals respectively received by the high frequency transceivers 21 to 26. Thus, only a high frequency signal with a specific circular polarization (such as left-hand circular polarization) can be delivered to the signal processor (shown later) of the WiFi base station.

Further, in this embodiment, the antenna controller 27 includes an electronic scan switch circuit board 272 to rapidly switch and select one of the high frequency transceivers 21, 22, 23, 24, 25 or 26 electronically based on a signal transmitting/receiving request output by the signal processor to thereby transmit or receive a circularly polarized high frequency signal. In this embodiment, the frequency of the circularly polarized high frequency signals transmitted or received by the high frequency transceivers 21, 22, 23, 24, 25 and 26 is approximately 2.4 GHz (the actual frequency may slightly vary upon the practical needs.)

It is noted that the number of high frequency transceivers of the interference-free antenna module can be one to six, depending on the practical needs, but not limited to six as cited in this embodiment. In addition, depending on the practical needs, each of the high frequency transceivers can be a different type of antenna, such as a waveguide slot array antenna or a sector horn antenna, which is capable of transmitting or receiving a circularly polarized high frequency signal, but not limited to the patch array antenna as cited in this embodiment, and all the high frequency transceivers do not need to be the same type of antenna. The high frequency signal can range between 2.3 GHz and 2.5 GHz, depending on the practical needs (such as in different environments), but not limited to 2.4 GHz as cited in this embodiment.

As stated, since the high frequency signals transmitted by the high frequency transceivers of the interference-free antenna module have a circular polarization characteristic (such as left-hand circular polarization), the circular polarization characteristic changes (such as from left-hand polarization to right-hand circular polarization) once the high frequency signals are reflected by an obstacle (such as a building or vehicle). Thus, as the circular polarization filter portion of the consumer equipment has a limit that only the high frequency signal with a specific circular polarization (such as left-hand circular polarization) can pass and then be delivered to the signal processor, the high frequency signals reflected by the obstacle cannot be delivered to the signal processor of the consumer equipment even if they enter the circular polarization antenna unit of the consumer equipment. Accordingly, the noises produced by the reflected high frequency signals are effectively suppressed, and the interference-free antenna module of the invention is able to raise the SNR of transmitting the high frequency signals.

Similarly, since the high frequency signals transmitted by the circular polarization antenna unit of the consumer equipment has a circular polarization characteristic (such as left-hand circular polarization), the circular polarization characteristic changes (such as from a left-hand circular polarization to a right-hand circular polarization) once the high frequency signals are reflected by an obstacle (such as a building or vehicle). Thus, the circular polarization filter portion of the antenna controller of the interference-free antenna module has a limit that only a high frequency signal with a specific circular polarization (such as left-hand circular polarization) can pass and be delivered to the signal processor of the WiFi base station, the high frequency signals reflected by the obstacle cannot be delivered to the signal processor of the WiFi base station even if they enter the high frequency transceivers of the interference-free antenna module. Accordingly, the noises produced by the reflected high frequency signals are effectively suppressed, and the interference-free antenna module of the invention is able to raise the SNR of transmitting the high frequency signals.

Since the circular polarization characteristic of the high frequency signals changes once the signals are reflected by the obstacle, the circular polarization characteristic can be restored (back to the left-hand circular polarization in the first transmission) when the high frequency signals are reflected again. In this case, although the circularly polarized high frequency signals (transmitted by the circular polarization antenna unit of the consumer equipment) which have been reflected twice can pass the circular polarization filter portion of the antenna controller of the interference-free antenna module and be delivered to the signal processor of the WiFi base station, the intensity of the high frequency signals has decayed to a very low level, and the signal transmission between the WiFi base station and the consumer equipment is not affected by the noises produced by the high frequency signals which have been reflected twice.

Similarly, although the circularly polarized high frequency signals (transmitted by the high frequency transceivers of the interference-free antenna module) which have been reflected twice can pass the circular polarization filter portion of the consumer equipment and be delivered to the signal processor, the intensity of the high frequency signals has decayed to a very low level, and the signal transmission between the WiFi base station and the consumer equipment is not affected by the noises produced by these high frequency signals which have been reflected twice.

Therefore, the interference-free antenna module can raise the transmission efficiency of transmitting high frequency signals between a WiFi base station and a consumer equipment, and the SNR of transmitting the high frequency signals is not decreased because of those high frequency signals which have been reflected twice.

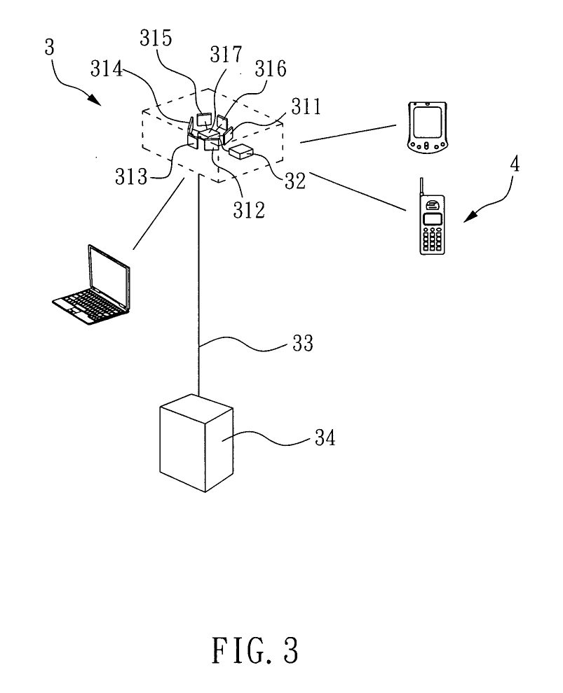

FIG. 3 is a schematic view of a WiFi network system according to an embodiment of the invention. As shown in FIG. 3, the WiFi network system includes a WiFi base station 3 and a consumer equipment 4. The distance between the WiFi base station 3 and the consumer equipment 4 can exceed 250 meters. In this case, the coverage of the WiFi base station 3 in the invention is far greater than that of a typical WiFi base station (the radius is about 75 to 150 meters).

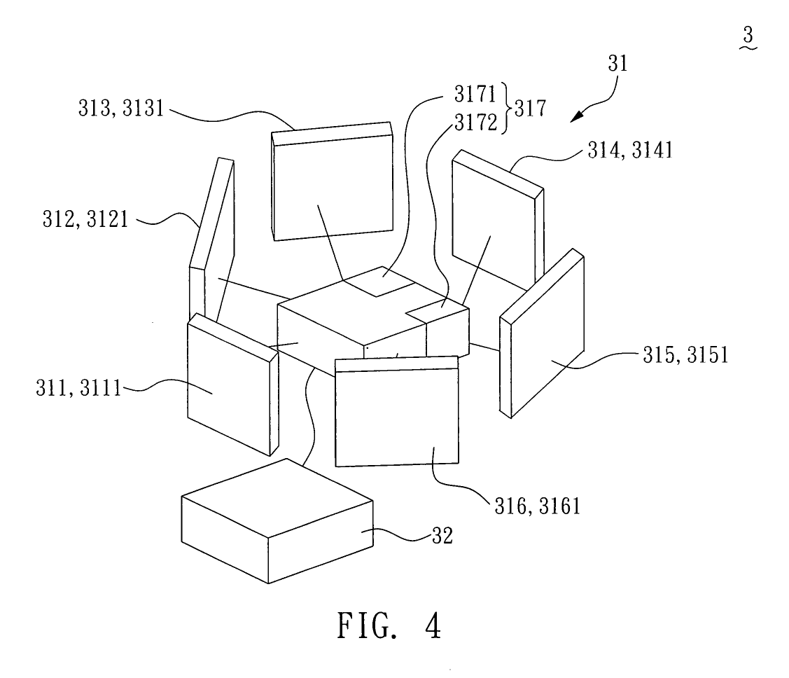

FIG. 4 is a schematic view of the WiFi base station 3 according to an embodiment of the invention. As shown in FIG. 4, the WiFi base station 3 includes an interference-free antenna module 31 and a first signal processor 32. The interference-free antenna module 31 has a plurality of first high frequency transceivers 311 to 316 and a first antenna controller 317. The first high frequency transceivers 311 to 316 face different directions respectively. The first antenna controller 317 is electrically coupled to the first high frequency transceivers 311 to 316 respectively. In addition, the first antenna controller 317 is electrically coupled to the first signal processor 32 in order to select one of the first high frequency transceivers 311, 312, 313, 314, 315 or 316 based on a signal transmitting/receiving request output by the first signal processor 32 to thereby transmit or receive a circularly polarized first high frequency signal. Meanwhile, as shown in FIG. 3, the WiFi base station 3 is electrically coupled to a remote server 34 through a physical network line 33. In this embodiment, the physical network line 33 can be a network cable of a backbone network, and the remote server is a server located in a switch room.

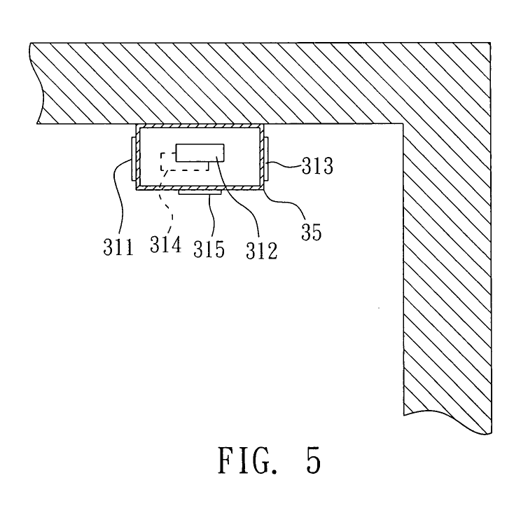

FIG. 5 is a schematic view of the WiFi base station 3 installed on the roof of a room according to an embodiment of the invention. As shown in FIG. 5, the WiFi base station 3, which has a metal case 35, is installed on the roof of a room. The first high frequency transceivers 311 to 316 are implemented respectively on the metal case 35 facing different directions to thereby transmit or receive the circularly polarized first high frequency signals at different directions.

FIG. 6 is a schematic view of the consumer equipment interference-free antenna module 4 according to an embodiment of the invention. As shown in FIG. 6, the consumer equipment 4 includes a consumer equipment interference-free antenna module 41 and a second signal processor 42. The consumer equipment interference-free antenna module 41 has a circular polarization antenna unit 411 to transmit or receive a circularly polarized second high frequency signal. In this embodiment, the circular polarization antenna unit 411 includes a horizontal antenna portion 4111, a vertical antenna portion 4112 and a signal mixing portion 4113, and the signal mixing portion 4113 is electrically coupled to the horizontal antenna portion 4111 and the vertical antenna portion 4112 respectively. In addition, a horizontal high frequency signal transmitted or received by the horizontal antenna portion 4111 and a vertical high frequency signal transmitted or received by the vertical antenna portion 4112 have a 90-degree phase difference.

In addition, since the circular polarization antenna unit 411 functions as a circular polarization filter, only a second high frequency signal with a specific circular polarization (such as a left-hand circular polarization) can be delivered to the second signal processor 41. Further, as shown in FIG. 3, one of the first high frequency transceivers 311, 312, 313, 314, 315 and 316 faces the consumer equipment 4 (in this case, the first high frequency transceiver 311). The consumer equipment 4 is a WiFi mobile phone.

The antenna module 31 shown in FIG. 4 has six first high frequency transceivers 311 to 316, which are patch array antennas, and each of them has a rectangle plate 3111, 3121, 3131, 3141, 3151, 3161 with a size of 5 cm×5 cm. The first antenna controller 317 includes a circular polarization filter portion 3171 to filter the first high frequency signals received by the high frequency transceivers 311 to 316 respectively. Thus, only a first high frequency signal with a specific circular polarization (such as a left-hand circular polarization) can be delivered to the first signal processor 32 of the WiFi base station 3.

Further, in this embodiment, the first antenna controller 317 includes an electronic scan switch circuit board 3172 to rapidly switch and select one of the first high frequency transceivers 311, 312, 313, 314, 315 and 316 electronically based on a signal transmitting/receiving request output by the first signal processor 32 to thereby transmit or receive a circularly polarized first high frequency signal. In this embodiment, the frequency of the first circularly polarized high frequency signals transmitted or received by the first high frequency transceivers 311, 312, 313, 314, 315 and 316 is around 2.4 GHz (the actual frequency may slightly vary upon the practical needs.)

As shown in FIG. 3, when the WiFi base station 3 receives a signal, which needs to be forwarded to the consumer equipment 4, through the physical network line 33, the WiFi base station 3 converts the signal into a corresponding circularly polarized first high frequency signal. Next, the first antenna controller 317 of the WiFi base station 3 selects the first high frequency transceiver 311 facing the consumer equipment 4 to transmit the first high frequency signal, and the circular polarization antenna unit 411 of the consumer equipment 4 thus receives the first high frequency signal.

In addition, when the consumer equipment 4 wishes to deliver a signal to the remote server 34, the circular polarization antenna unit 411 of the consumer equipment 4 transmits a corresponding second high frequency signal, with a circular polarization. In this case, the first antenna controller 317 of the WiFi base station 3 selects the first high frequency transceiver 311 facing the consumer equipment 4 to receive the second high frequency signal. Next, the WiFi base station 3 converts the received second high frequency signal into a circuit signal and forwards the signal to the remote server 34 through the physical network line 33.

It is noted that the number of first high frequency transceivers of the interference-free antenna module can be one to six, depending on the practical needs, but not limited to six as cited in this embodiment. In addition, depending on the practical needs, each of the high frequency transceivers can be a different type of antenna, which is capable of transmitting or receiving a circularly polarized high frequency signal, such as a waveguide slot array antenna or a sector horn antenna, but not limited to the patch array antenna as cited in this embodiment, and all the high frequency transceivers do not need to be the same type of antenna. The frequency of the first high frequency signal and the second high frequency signal can range between 2.3 GHz and 2.5 GHz, depending on the practical needs (such as in different environments), but not limited to 2.4 GHz as cited in this embodiment.

As stated, in this embodiment, since the WiFi base station 3 of the WiFi network system uses the first high frequency transceiver 311 of the interference-free antenna module 31 to transmit the first high frequency signal, which has a circular polarization characteristic (such as left-hand circular polarization), when the first high frequency signal is reflected by an obstacle (such as a building or vehicle), the circular polarization characteristic is changed (such as from left-hand circular polarization to right-hand circular polarization). Thus, as the circular polarization antenna unit 411 of the consumer equipment interference-free antenna module 41 of the consumer equipment 4 has a limit that only a first high frequency signal with a specific circular polarization (such as a left-hand circular polarization) can pass and be delivered to the second signal processor 42, the first high frequency signals reflected by the obstacle cannot be delivered to the second signal processor 42 of the consumer equipment 4 even if they enter the circular polarization antenna unit 411 of the consumer equipment interference-free antenna module 41 of the consumer equipment 4.

Similarly, since the high frequency signals transmitted by the circular polarization antenna unit 411 of the consumer equipment 4 have a circular polarization characteristic (such as a left-hand circular polarization), the circular polarization characteristic of the high frequency signals is changed (such as from left-hand to right-hand circular polarization) after being reflected by an obstacle (such as a building or vehicle). Thus, in this embodiment, as the circular polarization filter portion 3171 of the WiFi base station 3 of the WiFi network has a limit that only a high frequency signal with a specific circular polarization (such as a left-hand circular polarization) can pass and be delivered to the first signal processor 32, the high frequency signals reflected by the obstacle cannot be delivered to the first signal processor 32 of the WiFi base station 3 even if they enter the high frequency transceivers 311 to 316 of the interference-free antenna module of the WiFi base station 3 of the WiFi network system. Accordingly, the noises produced by the high frequency signals which have been reflected are effectively suppressed, and the WiFi network system of another embodiment can improve the transmission efficiency of the high frequency signals between a WiFi base station and a consumer device.

Since the circular polarization characteristic of the high frequency signals is changed after the signals being reflected by the obstacle, the circular polarization characteristic can be restored to the original circular polarization (such as the left-hand circular polarization) when the high frequency signals are reflected again. In this case, although the circularly polarized high frequency signals (transmitted by the circular polarization antenna unit of the consumer equipment), which have been reflected twice, can pass the circular polarization filter portion 3171 of the first antenna controller 317 of the WiFi base station 3 of the WiFi network system to be delivered to the signal processor 32, the strength of the high frequency signals is decayed to a very low level after being reflected twice, and the signal transmission between the WiFi base station and the consumer equipment is not affected by the noises produced by the high frequency signals, which have been reflected twice.

Similarly, although the circularly polarized high frequency signals (transmitted by the first high frequency transceivers 311 to 316 of the interference-free antenna module 312 of the WiFi base station 3 of the WiFi network system) can pass the circular polarization filter portion of the consumer equipment to the signal processor after being reflected twice, the strength of the high frequency signals is also decayed to a very low level after being reflected twice, and the signal transmission between the WiFi base station and the consumer equipment is not affected by the noises produced by the high frequency signals which have been reflected twice. Therefore, in the other embodiment, the WiFi network system can improve the transmission efficiency of a high frequency signal between the WiFi base station and the consumer equipment, and the SNR of transmitting the high frequency signal is not reduced by the high frequency signals which have been reflected twice. In addition, the system can effectively expand the coverage of the WiFi base station while maintaining a desired QoS.

Briefly, since the high frequency signals transmitted by the high frequency transceivers of the interference-free antenna module have a circular polarization characteristic (such as a left-hand circular polarization), and in this case the circular polarization characteristic of the high frequency signals is changed (such as from left-hand circular polarization to right-hand circular polarization) after being reflected by an obstacle (such as a building or vehicle), only a high frequency signal with a specific circular polarization (such as a left-hand circular polarization) can be delivered to the signal processor of the consumer equipment. The high frequency signals, which have been reflected by the obstacle, cannot be delivered to the signal processor of the consumer equipment even if they enter the circular polarization antenna unit of the consumer equipment, because their circular polarization characteristic is changed (in this case, it is changed to right-hand circular polarization). Accordingly, the noises produced by the high frequency signals which have been reflected are effectively suppressed, and the interference-free antenna module of the invention can improve the SNR and the transmission efficiency of transmitting the high frequency signals between the WiFi base station and the consumer equipment.

Similarly, since all of the high frequency transceivers respectively belonged to the antenna module in the WiFi base station and the consumer equipment of the WiFi network system can transmit or receive a circularly polarized high frequency signal, the corresponding consumer equipment (or WiFi base station) can easily receive the circularly polarized high frequency signal when the WiFi base station (or the consumer equipment) transmits the circularly polarized high frequency signal, and the SNR and the transmission efficiency of transmitting the high frequency signals are both improved. Therefore, the coverage of the WiFi base station of the WiFi network system can be expanded while the system remains a certain desired QoS.

Although the present invention has been explained in relation to its preferred embodiment, it is to be understood that many other possible modifications and variations can be made without departing from the spirit and scope of the invention as hereinafter claimed.

What is claimed is:

1. An interference-free antenna module, which is implemented in a wireless fidelity (WiFi) base station with a signal processor and applied in a high frequency signal transmission between the WiFi base station and a consumer equipment, the interference-free antenna module comprising:
a plurality of high frequency transceivers facing different directions respectively; and
an antenna controller electrically coupled to the high frequency transceivers respectively;
wherein the antenna controller is electrically coupled to the signal processor in order to receive a signal transmitting/receiving request output by the signal processor to accordingly select a high frequency transceiver to transmit or receive a circularly polarized high frequency signal.

2. The interference-free antenna module as claimed in claim 1, wherein the number of high frequency transceivers ranges from one to six.

3. The interference-free antenna module as claimed in claim 1, wherein each of the high frequency transceivers is a patch array antenna.

4. The interference-free antenna module as claimed in claim 1, wherein the antenna controller comprises a circular polarization filter portion to filter the high frequency signal respectively received by the high frequency transceivers.

5. The interference-free antenna module as claimed in claim 1, wherein each of the high frequency transceivers comprises a rectangle plate.

6. The interference-free antenna module as claimed in claim 1, wherein the antenna controller comprises an electronic scan switch circuit board.

7. The interference-free antenna module as claimed in claim 1, wherein the frequency of the high frequency signal ranges between 2.3 GHz to 2.5 GHz.

8. An interference-free antenna module, which is implemented in a consumer equipment with a signal processor and applied to a high frequency signal transmission between the WiFi base station and a consumer equipment, the interference-free antenna module comprising:
a consumer equipment interference-free antenna module and a second signal processor, wherein the consumer equipment interference-free antenna module has a circular polarization antenna unit to transmit or receive the circularly polarized second high frequency.

9. The consumer equipment interference-free antenna module as claimed in claim 8, wherein the circular polarization antenna unit comprises a horizontal antenna portion, a vertical antenna portion and a signal mixing portion, and the signal mixing portion is electrically coupled to the horizontal antenna portion and the vertical antenna portion respectively.

10. A WiFi network system, comprising:
a WiFi base station having an interference-free antenna module and a first signal processor, wherein the interference-free antenna module has a plurality of first high frequency transceivers and a first antenna controller electrically coupled to the first high frequency transceivers respectively, and the first antenna controller is electrically coupled to the first signal processor in order to receive a signal transmitting/receiving request output by the first signal processor to accordingly select one of the first high frequency transceivers to transmit or receive a circularly polarized first high frequency signal; and
a consumer equipment having a consumer equipment interference-free antenna module and a second signal processor, wherein the consumer equipment interference-free antenna module has a circular polarization antenna unit to transmit or receive a circularly polarized second high frequency signal;
wherein the first high frequency transceivers face different directions respectively, and one of the first high frequency transceivers faces the consumer equipment.

11. The WiFi network system as claimed in claim 10, wherein the WiFi base station is electrically coupled to a remote server through a physical network line.

12. The WiFi network system as claimed in claim 10, wherein the circular polarization antenna unit receives the first high frequency signal when the first antenna controller selects the first high frequency transceiver facing the consumer equipment to transmit the first high frequency signal.

13. The WiFi network system as claimed in claim 12, wherein the first antenna controller selects the first high frequency transceiver facing the consumer equipment to receive the second high frequency signal when the circular polarization antenna unit transmits the second high frequency signal.

14. The WiFi network system as claimed in claim 10, wherein the number of first high frequency transceivers ranges from one to six.

15. The WiFi network system as claimed in claim 10, wherein each of the first high frequency transceivers is a patch array antenna.

16. The WiFi network system as claimed in claim 10, wherein the first antenna controller comprises a first circular polarization filter portion to filter the first high frequency signal respectively received by the first high frequency transceivers.

17. The WiFi network system as claimed in claim 10, wherein each of the first high frequency transceivers comprises a first rectangle plate.

18. The WiFi network system as claimed in claim 10, wherein the first antenna controller comprises an electronic scan switch circuit board.

19. The WiFi network system as claimed in claim 10, wherein the frequency of the first high frequency signal and the frequency of the second high frequency signal range between 2.3 GHz to 2.5 GHz respectively.

20. The WiFi network system as claimed in claim 10, wherein the circular polarization antenna unit comprises a horizontal antenna portion, a vertical antenna portion and a signal mixing portion, and the signal mixing portion is electrically coupled to the horizontal antenna portion and the vertical antenna portion respectively.

21. The WiFi network system as claimed in claim 10, wherein the consumer equipment is a WiFi mobile phone.
